(19) United States
(12) Patent Application Publication
(10) Pub. No.: US 2004/0207515 A1
(43) Pub. Date: Oct. 21, 2004

(54) Method of controlling a distance between vehicles, and an apparatus thereof

(76) Inventor: Eui Yoon Chung, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/628,720

(22) Filed: Jul. 28, 2003

(30) Foreign Application Priority Data
Apr. 21, 2003 (KR) 10-2003-0025114

(51) Int. Cl. B60Q 1/00

(52) U.S. Cl. 340/435; 340/903

(57) ABSTRACT

A distance between vehicles is controlled based on an image detected by one stereo camera that is connected to a camera angle adjuster, so that deterioration of data processing speed can be prevented by adjusting the camera angle according to predetermined conditions.

### FIELD OF THE INVENTION

Generally, this invention relates to a method for controlling the distance to a preceding vehicle and an apparatus thereof, and more particularly to a method for controlling the distance to a preceding vehicle and an apparatus thereof using a camera in which the angle with respect to the ground is adjustable.

### BACKGROUND OF THE INVENTION

Typically, ACC (Adaptive Cruise Control) has been studied for controlling the distance to a preceding vehicle so as to maintain a predetermined distance thereto.

In order to detect the distance between vehicles, laser radar, millimeter wave radar, a CCD (Charge Coupled Device), or a CMOS is provided to a vehicle. If a CCD, or a CMOS is employed to the vehicle, a stereo camera having a pair of CCD or CMOS is mounted on the vehicle for detecting a three-dimensional image of the preceding vehicle.

However, if one stereo camera is provided for detecting an image of the preceding vehicle, the stereo camera detects long and short distance images simultaneously so that the speed of data processing deteriorates. Accordingly, two stereo cameras should be mounted in the front of the vehicle so that one stereo camera detects a long distance image and the other stereo camera detects a short distance image.

### SUMMARY OF THE INVENTION

An exemplary method for controlling distance between vehicles according to this invention comprises the steps of detecting an image ahead of a vehicle; determining whether a preceding vehicle exists; controlling the vehicle speed based on a calculated distance between vehicles, if the preceding vehicle exists; determining whether the camera angle with respect to the ground (hereinafter, “camera angle with respect to the ground” is described as “camera angle”) is a predetermined upper angle; and adjusting the camera angle to a predetermined lower angle if it is the predetermined upper angle.

In a further embodiment, at the step of controlling the vehicle speed based on the calculated distance between vehicles, the vehicle speed is controlled such that the distance between vehicles is maintained at a predetermined distance.

In another further embodiment, the method for controlling distance between vehicles comprises maintaining the camera angle if it is not the predetermined upper angle.

A further exemplary method for controlling distance between vehicles according to this invention comprises detecting an image ahead of a vehicle; determining whether a preceding vehicle exists; if the preceding vehicle does not exist, determining whether a camera angle is a predetermined lower angle; and if the camera angle is the predetermined lower angle, adjusting it to a predetermined upper angle.

In a further embodiment, the method for controlling distance between vehicles comprises maintaining the camera angle if the detected camera angle is not the predetermined lower angle.

An exemplary apparatus for controlling a distance between vehicles comprises a stereo camera detecting an image ahead of a vehicle; a camera angle adjuster detecting and adjusting a camera angle; and a controller controlling a vehicle speed and the camera angle based on the detected image ahead of the vehicle and the detected camera angle.

In a further embodiment, the controller can be realized by one or more processors activated by predetermined software, and the predetermined software can be programmed to perform predetermined steps comprising controlling a vehicle speed based on the detected image ahead of the vehicle; and controlling the camera angle based on the detected image ahead of the vehicle and the detected camera angle.

In another further embodiment, the stereo camera comprises a pair of CCD or CMOS.

In a further embodiment, the step of controlling the vehicle speed comprises calculating a distance between vehicles based on the image ahead of the vehicle; and transmitting the speed control signal to an ECU based on the calculated distance between the vehicles so as to activate a throttle valve or a brake.

In another further embodiment, the predetermined step of controlling the camera angle comprises determining whether the preceding vehicle exists; and controlling the camera angle to be a predetermined lower angle if the preceding vehicle exists.

In another further embodiment, the step of controlling the camera angle comprises controlling the camera angle to be a predetermined upper angle if the preceding vehicle does not exist.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an apparatus for controlling a distance between vehicles according to a preferred embodiment of the present invention; and

FIG. 2 is a flow chart of a method for controlling a distance between vehicles according to a preferred embodiment of the present invention.

### DETAILED DESCRIPTION OF THE PREFERRED EMBODIMENTS

Preferred embodiments of the present invention will hereinafter be described in detail with reference to the accompanying drawings.

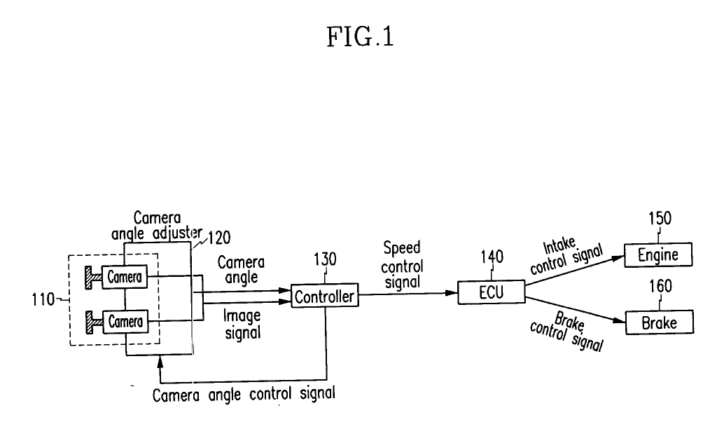

As shown in FIG. 1, an apparatus for controlling a distance between vehicles comprised a stereo camera 110; a camera angle adjuster 120; and a controller 130. The stereo camera 110 is mounted in the front of a vehicle, and it detects an image ahead of the vehicle. Preferably, the stereo camera 110 has a pair of CCDs (Charge Coupled Devices) or a pair of CMOS. The camera angle adjuster 120 is connected to the stereo camera 110 so as to adjust a camera angle. Accordingly, as the camera angle increases, the camera can detect the image ahead of the vehicle at a longer distance. To the contrary, as the camera angle decreases, the camera can detect the image ahead of the vehicle at a shorter distance.

In a preferred embodiment, the camera angle is set with two steps so that the camera angle can be either a predetermined upper angle for detecting an image a long distance ahead of the vehicle or a predetermined lower angle for detecting an image a short distance ahead of the vehicle.

The image signals detected by the stereo camera 110 and the camera angle detected by the camera angle adjuster 120 are transferred to the controller 130. The controller 130 can be realized by one or more processors activated by software, which may be selected and programmed by a person of ordinary skill in the art based on the teachings herein.

The controller 130 processes the image signals from the stereo camera 110. If a preceding vehicle is detected in the detected image from the stereo camera 110, the controller 130 calculates the distance between the vehicles and transmits a speed control signal to the ECU 140 based on the calculated distance. The ECU controls the throttle valve for controlling intake flow to an engine 150, or a brake 160, so that the distance between the vehicles is maintained to be a predetermined amount.

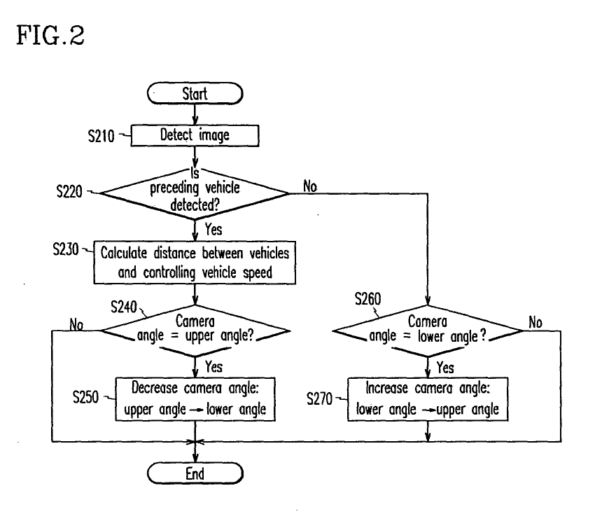

FIG. 2 illustrates a method for controlling a distance between vehicles in which the camera angle is adjusted according to a preferred embodiment of the present invention. The image ahead of the vehicle is detected by the stereo camera 110 mounted in the front of the vehicle at step S210, and the image is transmitted to the controller 130. The controller 130 determines whether the preceding vehicle exists at step S220, and if it does, the controller transmits the speed control signal to the ECU 140 so that the distance between the vehicles is maintained to be a predetermined amount at step S230.

The camera angle is detected by the camera angle adjuster 120, and is transmitted to the controller 130 so that the controller 130 determines whether the camera angle is the predetermined upper angle at step S240.

If the detected camera angle is determined to be the predetermined upper angle, it is adjusted to be the predetermined lower angle by the camera angle adjuster 120 at step S250.

Preferably, if the detected camera angle is determined to be the predetermined lower angle, the camera angle is maintained.

In the step S220, if the preceding vehicle does not exist, the camera angle is detected by the camera angle adjuster 120 and is transmitted to the controller 130 so that the controller 130 determines whether the camera angle is the predetermined lower angle at step S260.

If the detected camera angle is determined to be the predetermined lower angle, it is adjusted to be the predetermined upper angle at step S270.

Preferably, if the detected camera angle is determined to be the predetermined upper angle, it is maintained.

As shown above, according to a preferred embodiment of this invention, the distance between vehicles is controlled based on the image detected by one stereo camera connected to the camera angle adjuster so that a deterioration of data processing speed can be prevented by adjusting the camera angle according to predetermined conditions.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method for controlling a distance between vehicles utilizing at least one camera mounted on one vehicle, comprising:
detecting an image of an area ahead of the vehicle;
determining whether a preceding vehicle exists;
controlling vehicle speed based on a calculated distance between the vehicle and the preceding vehicle, if the preceding vehicle exists;
determining whether a camera angle is a predetermined upper angle; and
adjusting the camera angle to a predetermined lower angle if it is the predetermined upper angle.

2. The method of claim 1, wherein the controlling of the vehicle speed controls the vehicle speed such that the distance between vehicles is maintained at a predetermined distance.

3. The method of claim 1, further comprising maintaining the camera angle if it is not determined to be the predetermined upper angle.

4. A method for controlling a distance between vehicles utilizing at least one camera mounted on one vehicle, comprising:
detecting an image of an area ahead of the vehicle;
determining whether a preceding vehicle exists;
determining whether a camera angle is a predetermined lower angle; and
adjusting the camera angle to a predetermined upper angle if it is the predetermined lower angle.

5. The method of claim 4, further comprising maintaining the camera angle if the camera angle is not determined to be the predetermined lower angle.

6. An apparatus for controlling a distance between vehicles, comprising:
a stereo camera detecting an image of an area ahead of a vehicle;
a camera angle adjuster detecting and adjusting a camera angle; and
a controller controlling a vehicle speed and the camera angle based on the detected image of the area ahead of the vehicle and the detected camera angle.

7. The controlling apparatus of claim 6, wherein the controller executes instructions for:
controlling a vehicle speed based on the detected image of the area ahead of the vehicle; and
controlling the camera angle based on the detected image and the detected camera angle.

8. The controlling apparatus of claim 7, wherein the controlling of the vehicle speed comprises:
calculating a distance between vehicles based on the image of the area ahead of the vehicle; and
transmitting a speed control signal to an ECU based on the calculated distance between vehicles so as to control a throttle valve or a brake.

9. The controlling apparatus of claim 7, wherein the controlling of the camera angle comprises:
determining whether the preceding vehicle exists; and
controlling the camera angle to be a predetermined lower angle if the preceding vehicle exists.

10. The controlling apparatus of claim 9, wherein the controlling of the camera angle further comprises controlling the camera angle to be a predetermined upper angle if the preceding vehicle does not exist.

11. The controlling apparatus of claim 8, wherein the controlling of the camera angle comprises determining whether the preceding vehicle exists; and controlling the camera angle to be a predetermined lower angle if the preceding vehicle exists.

12. The controlling apparatus of claim 11, wherein the controlling of the camera angle further comprises controlling it to be a predetermined upper angle if the preceding vehicle does not exist.

13. The controlling apparatus of claim 6, wherein the stereo camera comprises a pair of CCD or CMOS.
